(19) United States
(12) Patent Application Publication
(10) Pub. No.: US 2017/0248680 A1
(43) Pub. Date: Aug. 31, 2017

(54) INDICATING LOCATION OF A LOCK

(71) Applicant: ROLLOCK OY, Espoo (FI)

(72) Inventor: Hannu KANKKUNEN, Espoo (FI)

(73) Assignee: ROLLOCK OY, Espoo (FI)

(21) Appl. No.: 15/511,349

(22) PCT Filed: Sep. 15, 2015
(86) PCT No.: PCT/FI2015/050616

§ 371 Date: Mar. 15, 2017

(30) Foreign Application Priority Data
Sep. 17, 2014 (FI) 20145813

(51) Int. Cl. G01S 5/02; G08B 21/18; E05B 47/00; E05B 17/10; E05B 19/00; E05B 41/00; G01S 3/28; E05B 17/00

(52) U.S. Cl. CPC G01S 5/0252; G01S 3/28; G08B 21/18; E05B 17/0083; E05B 17/10; E05B 19/0088; E05B 41/00; E05B 47/0001; E05B 2047/0072; E05B 2047/0067

(57) ABSTRACT

Lock system, mobile device and method for indicating the location of a lock with a mobile device, which mobile device sends and receives a radio signal and communicates with the lock via radio-frequency communication, wherein the lock is a lock that is openable electrically and by radio-frequency communication. In the solution of the invention the direction and/or strength of a radio transmission sent by a lock is measured with a mobile device, the location and/or direction of the lock in relation to the mobile device is determined on the basis of the measurement, and the location of the lock and/or the direction towards the lock is indicated with the mobile device to the user of the mobile device.

### FIELD OF THE INVENTION

The invention relates to a method, a mobile device and a lock arrangement, by means of which a user can be guided to a lock.

### BACKGROUND OF THE INVENTION

Known in the art are door locks comprising a lock case and a locking latch, which door locks can be opened and closed mechanically. Also known in the art are electrical locks, which can be controlled to open and close by means of electrical commands and electrical opening means. In prior-art arrangements electrical locks can be adapted to receive opening commands and closing commands also wirelessly, e.g. by means of Bluetooth or WLAN.

In prior-art locks, which are controlled wirelessly, a user does not necessarily know the precise location of a lock when the user has opened the lock because the lock can be opened wirelessly from many meters away. This is a problem e.g. in situations in which a visually impaired person approaches a door. Also, if there are a number of doors side by side, a user does not necessarily know which door his/her key opens. This type of situation can be, for example, when a user uses a door or a lock for the first time.

### BRIEF DESCRIPTION OF THE INVENTION

The aim of the current invention is to achieve a new type of method, mobile device and lock arrangement, by means of which a user can be guided to a lock.

In the solution of the invention a mobile device sends and receives a radio signal and communicates with a lock via radio-frequency communication.

The lock is a lock that is openable electrically and by means of radio-frequency communication. In the solution of the invention the direction and/or strength of a radio transmission sent by a lock is measured with a mobile device, the location and/or direction of the lock in relation to the mobile device is determined on the basis of the measurement, and the location of the lock and/or the direction towards the lock is indicated to the user of the mobile device. In the solution of the invention recorded in a mobile device is an electronic key, which authorizes the opening of a certain lock.

In one embodiment of the invention the mobile device indicates to the user the location of the lock only after the lock has confirmed that the mobile device has the right to open the lock.

In one embodiment of the invention the location of the lock is indicated to the user with light, sound or vibration or on the display of a device by indicating the direction of the lock with an indicator, e.g. with an arrow. The light or vibration can be periodic and the time interval of the periods can shorten when the mobile device turns to point in the direction of the lock, and can lengthen when the mobile device turns away from the direction of the lock. Also the type, such as e.g. front door or back door, of the lock and/or of the door can be indicated to the user e.g. as text, sound or speech.

In one embodiment of the invention the mobile device uses WLAN technology, Bluetooth technology and/or some other short-range radio technology for communicating with the lock.

The solution according to the invention now presented has some significant advantages when it is compared to prior-art solutions. By means of the solution of the invention, a user can be guided to a lock with a mobile device functioning as a key. This is useful e.g. to visually impaired people or to the type of people that are using the door or the lock for the first time.

In one embodiment of the invention also a lock installed in a door or a device in the proximity of a lock or a door can indicate its location to a user, e.g. with light or sound, such as with a sound signal or speech. This further facilitates finding the correct lock. A lock can e.g. indicate its location when the mobile device has opened the lock or has received from the lock authorization for opening the lock.

In one embodiment of the invention a lock can indicate its location to a user also without an indication occurring in the mobile device. In this embodiment it is not necessary at all to indicate the location of the lock with a mobile device but instead only the lock indicates its location to the user, e.g. with a light in connection with the lock or with a sound associated with the lock, such as with a sound signal or speech. In this embodiment the mobile device can be simpler because it does not need to guide a user towards a lock and does not need to measure the strengths of signals sent by a lock. In this embodiment by means of an antenna in the lock the strength of a signal sent by a mobile device is measured and the distance of the mobile device from the lock is determined, and it is determined whether the mobile device is approaching the lock or moving away from it. The lock can indicate its location by means of a light in connection with the lock, with a sound or vibration associated with the lock. The light, sound or vibration can be periodic and the time interval of the periods can shorten when the mobile device approaches or turns to point in the direction of the lock, and can lengthen when the mobile device recedes from the lock or turns away from the direction of the lock. A lock can e.g. indicate its location when the mobile device has opened the lock or has received from the lock authorization for opening the lock.

In one embodiment of the invention the location of the lock is known and it can be notified to a mobile device already before the mobile device enters the vicinity of the lock. The location of the lock can be expressed as geographic data, such as a GPS coordinate, or as a coordinate of some other position location system, such as an indoor position location system. A mobile device can, if the user so desires or automatically, guide the user to a lock from a longer distance away by means of coordinates.

### BRIEF DESCRIPTION OF THE FIGURES

In the following, the invention will be described in more detail by the aid of some embodiments with reference to the drawings 1-3, wherein

FIG. 1 presents a schematic view of the operating principle of one embodiment of the invention;

FIG. 2 presents the structure of a lock arrangement according to one embodiment of the invention, and

FIG. 3 presents as a functional diagram the operation of a lock arrangement according to one embodiment of the invention.

### DETAILED DESCRIPTION OF THE INVENTION

In the solution of the invention the location of a lock can be indicated so that a use more easily finds his/her way to a lock he/she can open. The location of a lock can be indicated with a mobile device or with the lock, or with both the mobile device and the lock. In the solution according to the invention a mobile device is used that sends and receives a radio signal and communicates with the lock via radio-frequency communication. In the solution of the invention the lock is a lock that is openable electrically and by means of radio-frequency communication.

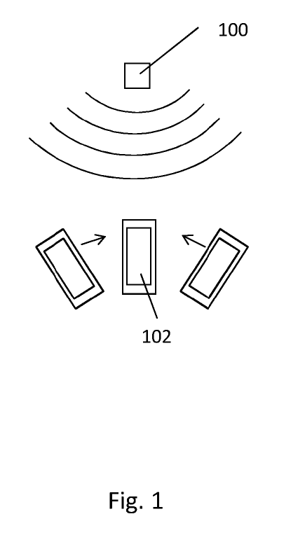

FIG. 1 presents a schematic view of the operating principle of one embodiment of the invention. In the schematic diagram is a lock 100, which comprises a lock case that can be fixed into a door, which lock case comprises a locking latch and a latch mechanism. A mobile device 102, such as a mobile phone, tablet, smartwatch, an article of intelligent clothing, electronic key or some other portable mobile device, is in the proximity of the lock in such a way that the lock 100 and the mobile device 102 can communicate with each other. Recorded in the mobile device 102 is an electronic key, which authorizes the opening of a certain lock, in this case the lock 100. The direction and/or strength of a radio transmission sent by the lock 100 are measured with the mobile device 102. When the mobile device 102 moves in the direction of the lock 100 the strength of the signal increases and the mobile device 102 detects this. In one embodiment of the invention with the mobile device 102 it can also be detected whether the mobile device 102 is pointing in the direction of the lock 100 or away from the lock 100 and whether the mobile device 102 is turning to the direction of the lock 100 or away from it. In FIG. 1 the signal sent by the lock 100 is described with curves.

On the basis of the measurement performed, the location and/or direction of the lock 100 in relation to the mobile device 102 is determined, e.g. on the basis of the strengths of the signals measured from at least one antenna. When the direction of the lock 100 has been determined in the mobile device 102, the location of the lock 100 and/or the direction towards the lock 100 is indicated to the user of the mobile device 102. The mobile device can measure the location of a lock 100 continuously or at certain intervals in such a way that the location can be indicated to the user reliably when the mobile device 102 moves.

In the mobile device 102, the location of the lock 100 is indicated to the user with light, sound or vibration or on the display of a device by indicating the direction of the lock with an indicator, e.g. with an arrow. In one embodiment of the invention the light or vibration is periodic and the time interval of the periods shortens when the mobile device 102 turns to point in the direction of the lock 100 and/or approaches the lock 100, and lengthens when the mobile device 102 turns away from the direction of the lock 100 or moves farther away from the lock 100. In one embodiment of the invention the indication can be sound, e.g. a voice message or recorded or synthesized speech. Also the type or location, such as the front door or back door, of the lock can be told to the user as text, by means of sound or by means of speech.

In one embodiment of the invention the mobile device 102 indicates to the user the location of the lock 100 only after the lock 100 has confirmed that the mobile device 102 has the right to open the lock 100.

In one embodiment of the invention also the lock indicates its location to the user, e.g. with a light in connection with the lock, with a sound associated with the lock or with a vibration. The indication means in connection with a lock can be integrated into the lock or can be a separate device in connection with a lock and/or with a door. In one embodiment of the invention only the lock indicates its location to the user, e.g. with light, sound or vibration. In one embodiment of the invention the indication implemented by a lock can be sound, e.g. a voice message or recorded or synthesized speech. In these embodiments by means of an antenna in the lock the strength of a signal sent by a mobile device can be measured and the distance of the mobile device from the lock can be determined, and/or it can also be determined whether the mobile device is approaching the lock or moving away from it. A lock can indicate its location by means of a light in connection with the lock, by means of a sound associated with the lock or by means of a vibration. The light, sound or vibration can be periodic and the time interval of the periods can shorten when the mobile device approaches or turns to point in the direction of the lock, and can lengthen when the mobile device recedes from or turns away from the direction of the lock. A lock can e.g. indicate its location when the mobile device has opened the lock or has received from the lock authorization for opening the lock.

In one embodiment of the invention the mobile device comprises at least two antennas, which are directional antennas, in which the front-to-back ratio of the antenna is high, and the mobile device determines on the basis of the signals measured from the antennas the location and/or direction of the lock in relation to the mobile device. In this case the mobile device is able to detect in precisely which direction the lock is in relation to the mobile device and whether the mobile device is pointing towards the lock or away from the lock.

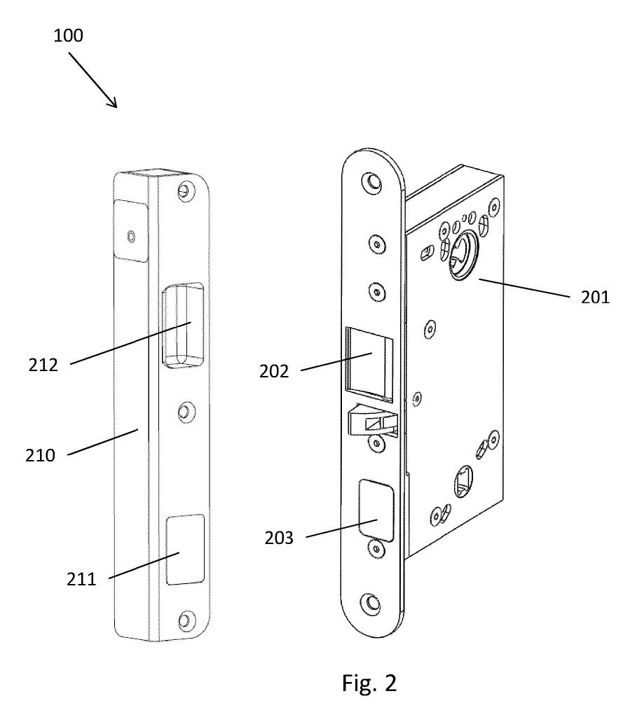

FIG. 2 presents by way of example the structure of a lock 100 according to one embodiment of the invention. The lock 100 comprises a lock case 201 and a counterpart 210 of the lock. The lock case 201 comprises a locking latch 202 and a latch mechanism. The latch mechanism comprises electrical means for opening and/or closing the locking latch.

Arranged into connection with the lock case 201 is at least one antenna, and connected to the antenna means for receiving radio signals, by the aid of which means the lock arrangement is adapted to communicate with a mobile device and to receive commands from a mobile device functioning as a key. In one embodiment of the invention the antenna of the lock arrangement can also be in the counterpart of the lock. The counterpart 210 of the lock presented in FIG. 2 comprises an aperture 212 for the locking latch of the lock.

In one embodiment of the invention the counterpart 210 of the lock can also comprise means 211 for sending electrical power. The counterpart 210 of the lock can be fixed into the door frame at a point corresponding to the lock of the door, and wiring to the counterpart 210 of the lock is arranged via the door frame. The means for receiving 203 and for sending 211 electrical power can be coils in the solution according to the invention. A lock environment is characteristically narrow and high in structure. The electronics used in the arrangement according to the invention can be disposed inside the lock to some extent more freely than the coils that transfer power—the coils, on the other hand, must be brought close to each other on the front surfaces of the lock and of the counterpart. The coils can be implemented to be planar in structure (planar coils). The means for receiving and for sending electrical power can be implemented in the manner described in patent application FI20135636. The lock arrangement can be adapted to transmit a signal of the antennas, and/or a signal formed by the means receiving a radio signal, from the counterpart 210 of the lock to the lock case 201 via the means adapted for sending 211 and receiving 203 electrical power.

In one embodiment of the invention the lock arrangement functions mechanically and the mechanical lock can also be opened and/or closed electrically.

In the arrangement according to the invention information can be wirelessly sent between the lock arrangement and a mobile device. The information can be, for example, requests for opening or closing the lock. The information transfer can be implemented by the aid of an antenna and by the aid of the means used for receiving radio signals.

In the solution according to the invention the information transfer is digital and authentication methods and/or encryption methods to ensure data security can be used in a lock application, by means of which methods it is ensured that the lock reacts only to commands transmitted by an identified counterpart. An unauthorized device that does not know the correct encryption parameters cannot create or send to the lock a request in an acceptable format and therefore cannot mislead the lock into switching to the incorrect operating mode.

The aim of authentication is therefore to ensure that the devices communicating with each other recognize one another. In this way, a fraudulent device cannot control one of the devices. Likewise the transmission of information to a fraudulent device is prevented. Authentication can be performed before permitting use of the service. Authentication can be one-way (server identifies user) or two-way (the service identifies user, and the user the service).

After successful authentication, information, which is encrypted, can be transferred between the lock arrangement and the mobile device. Various encryption technologies used in telecommunications or in computers can be used as encryption methods for encrypting the messages of the information transfer. Encryption means the converting of the plain text information to be encrypted into a type of format that makes clarification of the original information either impossible or too expensive (i.e. breaking the encryption takes too much time or resources compared to the value of the encrypted information).

The handling of encrypted information is generally two-directional: the information to be encrypted can be converted into an unreadable format for encrypting the information and correspondingly the encrypted information can be returned back to the original format for utilizing it. Examples of algorithms to be used for the encryption of the information are, inter alia, DES, AES and Blowfish.

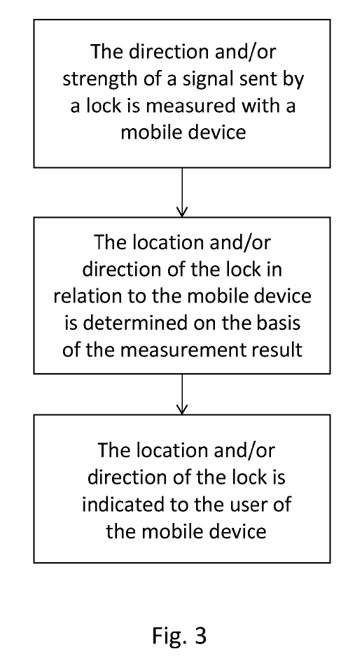

FIG. 3 presents a functional diagram of the operation according to one embodiment of the invention. By means of the antenna and the transmitter-receiver that are in a mobile device, it is measured whether a lock sending a radio signal is in the vicinity. When a lock sending a radio signal comes inside the measuring range of the mobile device, the strength and/or direction of the signal is measured at the point in question. When a mobile device is moved or its attitude is changed, a new measurement result about the strength of the received signal is obtained. If the strength of the signal increases, the mobile device can be interpreted as moving in the direction of the lock whereas if the signal level decreases, the mobile device can be interpreted as moving farther away from the lock. By means of the measured signals, therefore, the location and/or direction of the lock in relation to the mobile device can be determined. By means of the determination of the direction and/or location, the location of the lock and/or the direction towards the lock is indicated with the mobile device to the user of the mobile device.

In one embodiment of the invention the mobile device can have two antennas, by means of which a radio signal sent by a lock can be measured. Determination of the location and direction of a lock can be improved by means of the two antennas. Especially when the antennas are directional antennas and their radiation lobes are directed in different directions to each other, the precision of the determination of the location and/or direction of a lock can be improved further. If, for example, the antenna of a mobile device, the radiation lobe of said antenna being directed in a first direction, receives a stronger signal than an antenna with a radiation lobe directed in a second direction, the lock can be interpreted as being in the direction of the radiation lobe of the first antenna.

When it is desired to open a door lock from a mobile device, the mobile device sends a request to the lock of the door for opening the lock. Before sending a command over a wireless interface, the command can be encrypted. If encryption is used, the request can be sent after encryption from a device sending a radio signal to the lock arrangement, and the lock arrangement can receive the request utilizing the antenna of the lock arrangement and the means for receiving a radio signal. When the lock of the door receives the message, the encryption is decrypted and the content of the message interpreted. After this, the lock executes the command, in other words e.g. opens the lock, locks the lock, and/or sends the status information of the lock to the device sending the radio signal if the lock arrangement interprets the mobile device as having the right to present requests, i.e. the device sending a radio signal is identified by means of an electronic key or other identification data recorded in said mobile device.

If information is sent from the lock arrangement as a radio signal to the mobile device, the system can function in such a way that the lock arrangement encrypts the message (e.g. its status information) and sends it utilizing its antenna and the transmitter-receiver. Correspondingly, the mobile device receives the message. When the encryption of the message is decrypted in the mobile device, the content of the message can be read.

In one embodiment of the invention the location of the lock is known and it can be notified to a mobile device already before the mobile device enters the vicinity of the lock. The location of the lock can be expressed as geographic data, such as a GPS coordinate, or as a coordinate of some other position location system, such as an indoor position location system. In one embodiment of the invention the location information of the lock can be sent to the device of a user together with an electronic key and/or an electronic key can include the location information of the lock. A mobile device can, if the user so desires or automatically, guide the user to a lock from a longer distance away by means of coordinates. In this way a user can be guided to a lock and/or to a door from a long distance away and from an area in which the mobile device cannot yet measure a radio transmission sent by the lock. When the user and mobile device arrive in the proximity of the lock by means of guidance, the mobile device can start to guide the user on the basis of the measurement results of a radio signal sent by the lock when the mobile device is so close to the lock that measurement is possible. In one embodiment of the invention the user can be guided close to the lock, e.g. approx. 5-10 meters from the lock, by means of location data, and indication of the location of the lock based on measurement of a radio signal is only started in this phase when close to the lock, even though indication of the location of the lock based on measurement of a radio signal would be possible even farther from the lock. It is also possible to use both guidance methods in parallel, i.e. in this case guidance based on position location data and measurement based on measuring a radio signal are used in parallel whenever possible. This further improves the accuracy of determining the location of a lock.

The location information of a lock can, in one embodiment of the invention, be utilized when opening the lock, e.g. in such a way that the device requesting opening of the lock additional sends to the lock the geographic data of the lock, and also the geographic data of the lock sent by the device requesting opening must correspond to the correct geographic data of the lock, in addition to corresponding to the correct electronic key, for the lock to be opened.

It is obvious to the person skilled in the art that the different embodiments of the invention are not limited solely to the examples described above, and that they may therefore be varied within the scope of the claims presented below. The characteristic features possibly presented in the description in conjunction with other characteristic features can also, if necessary, be used separately to each other.

1-16. (canceled)

17. A method for indicating the location of a lock with a mobile device, which mobile device sends and receives a radio signal and communicates with the lock via radio-frequency communication, wherein the lock is a lock that is openable electrically and by means of radio-frequency communication, wherein in the method:
the direction and/or strength of a radio transmission sent by a lock is measured with a mobile device,
the location and/or direction of the lock in relation to the mobile device is determined on the basis of the measurement, and
the location of the lock and/or the direction towards the lock is indicated with the mobile device to the user of the mobile device.

18. The method according to claim 17, wherein location information of the lock is sent to the mobile device together with an electronic key and/or the electronic key comprises the location information of the lock.

19. The method according to claim 17, wherein the location information of a lock is utilized when opening the lock in such a way that the device requesting opening of the lock additionally sends to the lock the geographic data of the lock, and also the geographic data of the lock sent by the device requesting opening must correspond to the correct geographic data of the lock, in addition to corresponding to the correct electronic key, for the lock to be opened.

20. The method according to claim 17, wherein the mobile device indicates to the user the location of the lock only after the lock has confirmed that the mobile device has the right to open the lock.

21. The method according to claim 17, wherein the location of the lock is indicated to the user with light, sound or vibration or on the display of the mobile device by indicating the direction of the lock with an indicator, e.g. with an arrow.

22. The method according to claim 21, wherein the light, sound or vibration is periodic and the time interval of the periods shortens when the mobile device turns to point in the direction of the lock and/or approaches the lock and lengthens when the mobile device turns away from the direction of the lock and/or moves farther away from the lock.

23. The method according to claim 17, wherein the mobile device comprises at least two antennas, which are directional antennas, in which the front-to-back ratio of the antenna is high, and the mobile device determines on the basis of the signals measured from the antennas the location and/or direction of the lock in relation to the mobile device.

24. The method according to claim 17, wherein the mobile device determines on the basis of the strength of the signals measured from at least one antenna the location and/or direction of the lock in relation to the mobile device.

25. The method according to claim 17, wherein the mobile device uses WLAN technology, Bluetooth technology and/or some other short-range radio technology for communicating with the lock.

26. The method according to claim 17, wherein the lock indicates its location to the user with light, sound or vibration.

27. A mobile device, which is adapted to send and receive a radio signal and to communicate with a lock via radio-frequency communication, wherein the lock is a lock that is openable electrically and by means of radio-frequency communication, wherein:
the mobile device is adapted to measure the direction and/or strength of a radio transmission sent by a lock,
the mobile device is adapted to determine the location and/or direction of the lock in relation to the mobile device on the basis of the measurement, and
the mobile device is adapted to indicate to the user of the mobile device the location of the lock and/or the direction towards the lock.

28. The mobile device according to claim 27, wherein the mobile device is adapted to indicate to the user the location of the lock only after the lock has confirmed that the mobile device has the right to open the lock.

29. The mobile device according to claim 27, wherein the mobile device comprises at least two antennas, which are directional antennas, in which the front-to-back ratio of the antenna is high, and the mobile device is adapted to determine on the basis of the signals measured from the antennas the location and/or direction of the lock in relation to the mobile device.

30. The mobile device according to claim 27, wherein the mobile device is adapted to determine on the basis of the strength of the signals measured from at least one antenna the location and/or direction of the lock in relation to the mobile device.

31. A lock system, which comprises at least one lock and at least one mobile device, wherein the mobile device is adapted to send and receive a radio signal and to communicate with a lock via radio-frequency communication, and wherein the lock is a lock that is openable electrically and by means of radio-frequency communication,
wherein
the mobile device is adapted to implement any method according claim 17 whatsoever.

32. The method according to claim 18, wherein the location information of a lock is utilized when opening the lock in such a way that the device requesting opening of the lock additionally sends to the lock the geographic data of the lock, and also the geographic data of the lock sent by the device requesting opening must correspond to the correct geographic data of the lock, in addition to corresponding to the correct electronic key, for the lock to be opened.

33. The method according to claim 18, wherein the mobile device indicates to the user the location of the lock only after the lock has confirmed that the mobile device has the right to open the lock.

34. The method according to claim 19, wherein the mobile device indicates to the user the location of the lock only after the lock has confirmed that the mobile device has the right to open the lock.

35. The method according to claim 18, wherein the location of the lock is indicated to the user with light, sound or vibration or on the display of the mobile device by indicating the direction of the lock with an indicator, e.g. with an arrow.

36. The method according to claim 19, wherein the location of the lock is indicated to the user with light, sound or vibration or on the display of the mobile device by indicating the direction of the lock with an indicator, e.g. with an arrow.
